(19) United States
(12) Patent Application Publication
(10) Pub. No.: US 2024/0217275 A1
(43) Pub. Date: Jul. 4, 2024

(54) TIRE AIR PRESSURE NOTIFICATION SYSTEMS AND METHODS OF OPERATION

(71) Applicant: Ford Global Technologies, LLC, Dearborn, MI (US)

(72) Inventor: Aed M. Dudar, Canton, MI (US)

(73) Assignee: Ford Global Technologies, LLC, Dearborn, MI (US)

(21) Appl. No.: 18/148,911

(22) Filed: Dec. 30, 2022

(51) Int. Cl. B60C 23/04; B60Q 9/00

(52) U.S. Cl. CPC B60C 23/0406; B60C 23/0447; B60Q 9/00

(57) ABSTRACT

This disclosure generally pertains to systems and methods related to tire air pressure notifications. An example method that can be executed by a processor in a vehicle can include detecting a tire inflation operation performed upon a wheel of the vehicle and determining that air is escaping out of a tire of the wheel of the vehicle during the tire inflation operation. The processor may then issue an alert based on determining that air is escaping out of the tire. The alert may be provided in various ways such as, for example, via a haptic signal transmitted through a vibration element located in the wheel of the vehicle and/or by waggling the wheel of the vehicle. In an example implementation, waggling the wheel of the vehicle may be carried out by the processor by operating a steering wheel control system of the vehicle.

### BACKGROUND

Filling air into a tire of a vehicle is a familiar and routine procedure for most people. However, in some cases, an individual who is coupling an air hose into a tire of a vehicle may fail to notice air escaping out through a valve stem of the tire, due to, for example, being distracted or being hearing impaired. It is therefore desirable to provide a solution that addresses the issue of preventing an escape of air through the valve stem of a tire when performing an air filling operation on the tire.

### BRIEF DESCRIPTION OF THE DRAWINGS

A detailed description is set forth below with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 shows an example vehicle that includes a tire pressure monitoring system in accordance with an embodiment of the disclosure.

FIG. 2 shows an example wheel containing some example components that can be included in a tire pressure monitoring system of a vehicle in accordance with an embodiment of the disclosure.

FIG. 3 shows a flowchart of an example method of operation of a tire pressure monitoring system in accordance with an embodiment of the disclosure.

FIG. 4 shows some example components that can be included in a vehicle that is equipped with a tire pressure monitoring system in accordance with an embodiment of the disclosure.

### DETAILED DESCRIPTION

### Overview

In terms of a general overview, certain embodiments described in this disclosure generally pertain to tire air pressure notification systems and methods of operation. An example method that can be executed by a processor in a vehicle can include detecting a tire inflation operation performed upon a wheel of the vehicle and determining that air is escaping out of a tire of the wheel of the vehicle during the tire inflation operation. The processor may then issue an alert based on determining that air is escaping out of the tire. The alert may be provided in various ways such as, for example, via a haptic signal transmitted through a vibration element located in the wheel of the vehicle and/or by waggling the wheel of the vehicle. In an example implementation, waggling or agitation the wheel of the vehicle may be carried out by the processor by operating a steering wheel control system of the vehicle.

### Illustrative Embodiments

The disclosure will be described more fully hereinafter with reference to the accompanying drawings, in which example embodiments of the disclosure are shown. This disclosure may, however, be embodied in many different forms and should not be construed as limited to the example embodiments set forth herein. It will be apparent to persons skilled in the relevant art that various changes in form and detail can be made to various embodiments without departing from the spirit and scope of the present disclosure. Thus, the breadth and scope of the present disclosure should not be limited by any of the above-described example embodiments but should be defined only in accordance with the following claims and their equivalents. The description below has been presented for the purposes of illustration and is not intended to be exhaustive or to be limited to the precise form disclosed. It should be understood that alternate implementations may be used in any combination desired to form additional hybrid implementations of the present disclosure. For example, any of the functionality described with respect to a particular device or component may be performed by another device or component. Furthermore, while specific device characteristics have been described, embodiments of the disclosure may relate to numerous other device characteristics. Further, although embodiments have been described in language specific to structural features and/or methodological acts, it is to be understood that the disclosure is not necessarily limited to the specific features or acts described. Rather, the specific features and acts are disclosed as illustrative forms of implementing the embodiments.

Certain words and phrases are used herein solely for convenience and such words and terms should be interpreted as referring to various objects and actions that are generally understood in various forms and equivalencies by persons of ordinary skill in the art. For example, the word “wheel” as used in this disclosure refers to a wheel assembly that can include a tire and a support structure for the tire. The support structure can include, for example, a metal hub, a hub cap, and a rim upon which the tire is mounted. However, in some instants, the word “wheel” and the word “tire” is used herein in an interchangeable manner.

Words such as “movement” and “motion” and words such as “angle” and “angular displacement” may be used interchangeably in the disclosure and must be interpreted in the context in which used.

The word “information,” as used herein with reference to a device, refers to any of various forms of information contained in data produced by a sensor and conveyed via a signal. For example, data produced by a tire pressure sensor can provide information about air pressure in a tire. The air pressure information may be provided in various forms such as, for example, in the form of absolute pressure values (35 psi, for example) or in the form of an intimation (“low pressure”). The word “sensor” may be used interchangeably with the word “detector.”

The word “vehicle” as used herein can be any of various types of vehicles such as, for example, a gasoline powered vehicle, an electric vehicle, a hybrid electric vehicle, a car, a sports utility vehicle (SUV), a truck, a van, a semi-trailer truck, a bus, a driver-operated vehicle, or an autonomous vehicle. The phrase “autonomous vehicle” as used in this disclosure generally refers to a vehicle that can perform at least a few operations without human intervention. The Society of Automotive Engineers (SAE) defines six levels of driving automation ranging from Level 0 (fully manual) to Level 5 (fully autonomous). These levels have been adopted by the U.S. Department of Transportation. Level 0 (L0) vehicles are manually controlled vehicles having no driving related automation. Level 1 (L1) vehicles incorporate some features, such as cruise control, but a human driver retains control of most driving and maneuvering operations. Level 2 (L2) vehicles are partially automated with certain driving operations such as steering, braking, and lane control being controlled by a vehicle computer. The driver retains some level of control of the vehicle and may override certain operations executed by the vehicle computer. Level 3 (L3) vehicles provide conditional driving automation but are smarter in terms of having an ability to sense a driving environment and certain driving situations. Level 4 (L4) vehicles can operate in a self-driving mode and include features where the vehicle computer takes control during certain types of equipment failures. The level of human intervention is very low. Level 5 (L5) vehicles are fully autonomous vehicles that do not involve human participation.

It must be understood that words such as “implementation,” “configuration,” “application,” “scenario,” “situation,” “case,” and “situation” as used herein represent abbreviated versions of the phrase “In an example (“implementation,” “configuration,” “application,” “scenario,” “situation,” “case,” “approach,” and “situation”) in accordance with the disclosure.” The word “example” as used herein is intended to be non-exclusionary and non-limiting in nature.

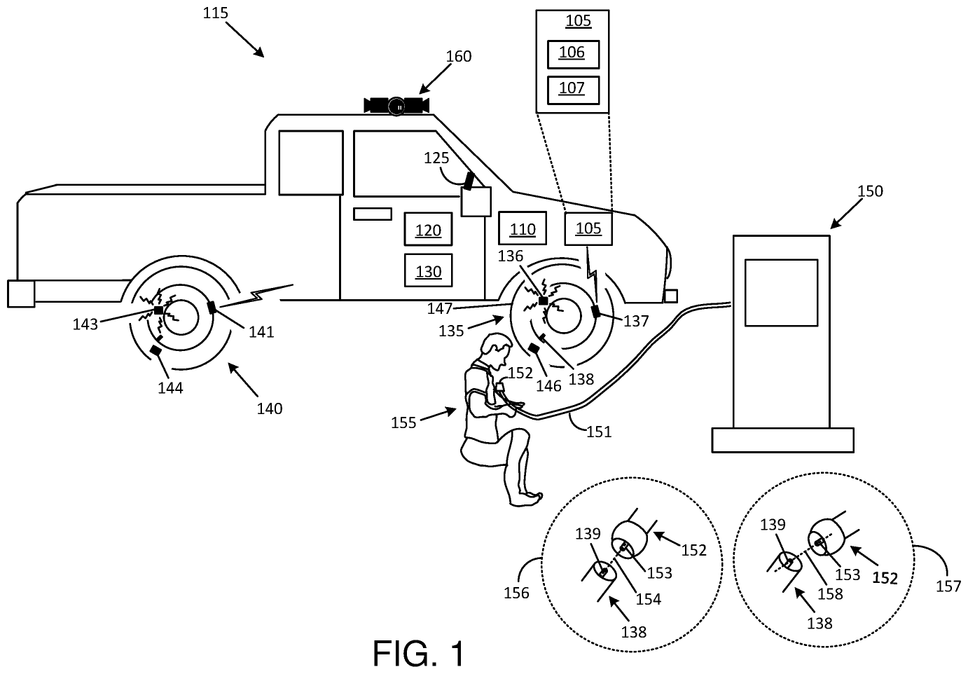

FIG. 1 shows an example vehicle 115 that includes a tire pressure monitoring system 105 in accordance with an embodiment of the disclosure. The vehicle 115 may further include a vehicle computer 110, an infotainment system 125, a sensor system 130, and a communications system 120. The tire pressure monitoring system 105 can include a processor 106 and a memory 107 in which is stored computer-executable instructions that can be executed by the processor 106 to perform various operations in accordance with the disclosure. The tire pressure monitoring system 105 can further include various devices that are provided in the vehicle 115, such as, for example in each wheel of the vehicle 115.

The vehicle computer 110 may perform various functions such as, for example, controlling engine operations (fuel injection, speed control, emissions control, braking, etc.), managing climate controls (air conditioning, heating etc.), detecting airbag activations, detecting component failures, detecting engine malfunctions, and issuing alerts (check engine light, bulb failure, low tire pressure, vehicle in blind spot, etc.).

In an example implementation, the tire pressure monitoring system 105 can be integrated into the vehicle computer 110 and the processor 106 can be configured to execute various actions carried out typically by the vehicle computer 110 as well as additional actions that are carried out in accordance with the disclosure. It must be understood that the phrase “tire pressure monitoring system 105” as used hereinafter generally refers to such an integrated system that may provide the functionality of a vehicle computer together with additional functionalities in accordance with the disclosure.

The infotainment system 125 can be an integrated unit that includes various components such as, for example, a radio, a CD player, a video player, and a navigation system. In an example implementation, the infotainment system 125 can include a display that may be used by the tire pressure monitoring system 105 to display (or outputting) alerts related to tire pressure. The display can include a graphical user interface (GUI) for use by a driver of the vehicle 115.

In the illustrated example, each of the wheels of the vehicle 115 includes or is associated with a vibration element that may be activated by the tire pressure monitoring system 105 to provide an alert when air is escaping out of a tire during a tire inflation operation, in accordance with the disclosure. For example, the passenger-side front wheel 135 of the vehicle 115 includes a vibration element 136, which upon receiving a command from the tire pressure monitoring system 105, provides an alert in the form of a haptic feedback signal. The haptic feedback signal may be transmitted in the form of a vibration through various parts of the passenger-side front wheel 135 (metal hub, rim, tire, etc.). The command may be generated by the tire pressure monitoring system 105 based on evaluating one or more sensor signals and determining that air is escaping out of a tire of the passenger-side front wheel 135 during a tire inflation operation.

In an example implementation, each vibration element 136 can be a motor. For example, in an example scenario, the vehicle 115 is an electric vehicle and the passenger-side front wheel 135 can include one or more electric motors (such as, for example, a motion motor and a steering motor). The vehicle computer 110 of the electric vehicle can activate the motion motor for moving the electric vehicle forwards or backwards and can activate the steering motor for changing a direction of movement of the electric vehicle.

In an example implementation of the vibration element 136 in accordance with disclosure, the tire pressure monitoring system 105 may communicate with the vehicle computer 110 to activate a motor or other component of the steering system, such as that used for lane change alerts, to waggle or agitate the passenger-side front wheel 135. Waggling the passenger-side front wheel 135 is one example of an alert that can be issued when air is escaping out of the tire of the passenger-side front wheel 135 during a tire inflation operation.

In another example implementation of the vibration element 136, the tire pressure monitoring system 105 may communicate with the vehicle computer 110 to activate one or both electric motors to rock the passenger-side front wheel 135 back and forth (rotate forward and rotate backwards cyclically). Rocking the passenger-side front wheel 135 is another example of an alert that can be issued when air is escaping out of the tire of the passenger-side front wheel 135 during a tire inflation operation.

It must be understood that the operations described herein with reference to the passenger-side front wheel 135 is equally applicable to all other wheels of the vehicle 115. Thus, for example, the passenger-side rear wheel 140 of the vehicle 115 can include a vibration element 143 that is similar to, or identical to, the vibration element 136 provided in the passenger-side front wheel 135 and can be activated in a manner similar to the one described above. Waggling and/or rocking can be performed on other wheels of the vehicle 115 as well.

The sensor system 130, which can be a part of the tire pressure monitoring system 105, can include various types of devices that are configured for sensing and detecting various conditions. In an embodiment in accordance with the disclosure, the sensor system 130 can include one or more cameras mounted upon the vehicle 115 and can also include one or more sensors provided in each of the wheels of the vehicle 115.

More particularly, in the illustrated example, a passenger-side front wheel 135 of the vehicle 115 includes a tire pressure sensor 137. The tire pressure sensor 137, which can be a part of a tire pressure monitoring system (TPMS), is configured to provide to the tire pressure monitoring system 105, measurements of the air pressure inside the tire of the passenger-side front wheel 135. A passenger-side rear wheel 140 includes a tire pressure sensor 141. The tire pressure sensor 141 is configured to provide to the tire pressure monitoring system 105, measurements of the air pressure inside the tire of the passenger-side rear wheel 140.

In an example implementation, each of the wheels of the vehicle 115 may further include an air flow sensor. For example, the passenger-side front wheel 135 of the vehicle 115 may include an air flow sensor 146. The air flow sensor 146 can be configured to provide to the tire pressure monitoring system 105, a sensor signal when air is escaping out of the tire of the passenger-side front wheel 135, and more particularly, in at least some cases, when air is escaping out of a valve stem 138 of the passenger-side front wheel 135. The passenger-side rear wheel 140 may include an air flow sensor 144. The air flow sensor 144 can be configured to provide to the tire pressure monitoring system 105, a sensor signal when air is escaping out of the tire of the passenger-side rear wheel 140, and more particularly, in at least some cases, when air is escaping out of the valve stem 142 of the passenger-side rear wheel 140.

The tire pressure sensor 137 may include a wireless transmitter (or wireless transceiver) that is configured to communicate wirelessly with the tire pressure monitoring system 105 for conveying to the tire pressure monitoring system 105, the sensor signals generated by the tire pressure sensor 137. The air flow sensor 146 may be similarly configured.

In an example implementation, the sensor signals may be directly communicated to the tire pressure monitoring system 105 via wireless signals that may occupy any of various frequency bandwidths and have any of various frequencies such as, for example, low-frequency (LF), very-high frequency (VHF), ultra-high frequency (UHF), and cellular frequencies. The wireless signals may be formatted in any of various communication formats such as, for example, Bluetooth® and near field communications (NFC).

In another example implementation, the sensor signals may be wirelessly communicated to the tire pressure monitoring system 105 via the communications system 120. The wireless signals may be formatted in any of various communication formats such as, for example, cellular, Wi-Fi, Wi-Fi direct, Ultra-Wideband (UWB), and Zigbee®. The communications system 120 may support such communications by use of a network (not shown). The network may include any one, or a combination of networks, such as a local area network (LAN), a wide area network (WAN), a telephone network, a cellular network, a cable network, a wireless network, and/or private/public networks such as the Internet.

In an example implementation, the tire pressure sensor 137 is arranged to generate sensor signals in response to receiving a wireless activation signal transmitted by the tire pressure monitoring system 105. The wireless activation signal may be, for example, a 125 kHz low-frequency (LF) signal. The sensor signals generated by the tire pressure sensor 137 and wirelessly transmitted to the tire pressure monitoring system 105 in response to the activation signal, can include information such as, for example, tire air pressure, tire identification, location of tire on vehicle, and/or temperature of tire. In an example scenario, a sensor signal generated by the tire pressure sensor 137 and wirelessly transmitted to the tire pressure monitoring system 105 in response to the activation signal, is a UHF signal (314.9 MHz-433.92 MHz). In other example scenarios, the sensor signal can be wirelessly transmitted using other communication formats such as, for example, Bluetooth®. When using Bluetooth®, the wireless sensor signal can include information such as a Bluetooth® address (used for wirelessly pairing the sensor to the tire pressure monitoring system 105), authentication information, codes, and encryption information.

In another case, the tire pressure sensor 137 may automatically transmit a wireless signal to the tire pressure monitoring system 105, upon detecting a drop in air pressure inside the tire 147 of the passenger-side front wheel 135. The drop in air pressure can be caused due to any of various contributing factors such as, for example, a puncture in the tire 147 (such as from a nail, spike, etc.) or a drop in ambient temperature outside the tire 147. More particularly, and in accordance with the disclosure, the drop in air pressure can be caused by an airflow out of the tire 147 via the valve stem 138 of the passenger-side front wheel 135, when an air hose 151 of an air station 150 is attached to the valve stem 138 for purposes of inflating the tire 147. The drop in air pressure may also be caused by a fault in the air hose 151 or a fault in the air station 150. The tire pressure monitoring system 105 may issue an alert based on a determination, using the received the wireless signal from the tire pressure sensor 137, that the air pressure is dropping when it should either be remaining unchanged or increasing. This drop in air pressure may be determined to be at a rate that exceeds a predetermined threshold.

In yet another case, the tire pressure sensor 137 may automatically transmit a wireless signal to the tire pressure monitoring system 105, upon detecting an excessive level of air pressure inside the tire 147 of the passenger-side front wheel 135 (e.g., outside of a defined range of air pressures). More particularly, and in accordance with the disclosure, the excessive level of air pressure can be due to overinflation of the tire 147 and the tire pressure monitoring system 105 issues an alert based on receiving the wireless signal from the tire pressure sensor 137.

As indicated above, the vehicle 115 can include one or more cameras. In an example implementation, the tire pressure monitoring system 105 may receive one or more images (digital image, video clip, real-time video, etc.) from one or more of the cameras such as, for example, from the camera 160, which can be a digital camera or a video camera, and has a 3600 field of view. The tire pressure monitoring system 105 may evaluate the images for executing various operations in accordance with the disclosure such as, for example, to detect a presence of the air station 150, a presence of the air hose 151, a presence of an individual 155 near the vehicle 115, and various actions performed by the individual 155 (particularly, actions associated with filling air into one or more tires of the vehicle 115, such as a person holding an air hose near a tire, kneeling beside a tire, etc.).

In the illustrated scenario, the tire pressure monitoring system 105 may evaluate one or more images obtained from the camera 160 and determine that the individual 155 has coupled, or intends to couple, a connector 152 of the air hose 151 to the valve stem 138 of the passenger-side front wheel 135 for purposes of inflating the tire 147. If done correctly, an air tight seal is formed between the connector 152 and the valve stem 138.

The valve stem 138 allows air to flow into the tire 147 when a pin 139 of the valve stem 138 is depressed by a rod 153 that is located in the connector 152 of the air hose 151. When the pin 139 is depressed in a direction that corresponds to a longitudinal axis of the rod 153, air can flow through the valve stem 138 and into the tire 147. The direction of depression of the pin 139 is indicated by a dashed line 154 that is shown inside dashed circle 156. Typically, the air pressure generated by the air station 150 is higher than the pressure of air inside the tire 147. Consequently, air is forced to through the connector 152 and into the tire 147 via the valve stem 138. The pin 139 is spring loaded and when undepressed, moves outwards and prevents air from escaping out of the tire 147.

However, if the pin 139 is pushed in a direction that is angular with respect to the longitudinal axis of the rod 153, air from inside the tire 147 can escape through the valve stem 138 and cause the tire 147 to deflate. The direction of movement of the pin 139 in this scenario is indicated by a dashed line 158 that is shown inside dashed circle 157. The air escaping through the valve stem 138 typically produces a hissing sound that can be heard by the individual 155. However, in some cases, the individual 155 may be distracted and may not hear the hissing sound. In some other cases, the individual 155 may not hear the hissing sound for other reasons such as, for example, due to being hearing impaired or due to being in a high ambient noise environment (garage, high traffic area, industrial area, etc.).

Consequently, and in accordance with the disclosure, the tire pressure monitoring system 105 of the vehicle 115 receives a wireless signal that provides information pertaining to the air escaping out from the tire 147 via the valve stem 138 during a tire inflation operation. The tire pressure monitoring system 105 may evaluate the information and respond by issuing an alert to inform the individual 155 of the air escape.

In an example implementation, the tire pressure monitoring system 105 receives the wireless signal from the tire pressure sensor 137 provided in the passenger-side front wheel 135. The tire pressure monitoring system 105 may issue an alert based on evaluating the information contained in the wireless signal. Evaluating the information contained in the wireless signal may include, for example, determining a rate of decrease of air pressure inside the tire of the passenger-side front wheel 135 and determining whether the rate of decrease is due to air escaping out of the tire during the tire inflation operation. In an example embodiment, the rate of decrease may be a preset value or threshold that may be defined in an empirical manner or may be based on historical data. The preset value can be selected to distinguish between air escaping out of the tire due to a puncture in the tire, for example, and air escaping out of the valve stem 138 due to an incorrect inflation procedure executed by the individual 155.

In another example implementation, the tire pressure monitoring system 105 receives the wireless signal from the air flow sensor 146 provided in the passenger-side front wheel 135. The air flow sensor 146 can include, for example, a detector circuit having a resistor that is heated by passage of current through the resistor. Air flow across the resistor causes the resistance of the resistor to drop. The drop in resistance is detected by that detector circuit and a wireless signal is generated by the air flow sensor 146 to inform the tire pressure monitoring system 105 of the air escape.

In another example implementation, the tire pressure monitoring system 105 may be configured to receive two wireless signals from the air flow sensor 146. A first wireless signal of the two wireless signals provides an indication to the tire pressure monitoring system 105 that air is escaping out of the tire 147 via the valve stem 138.

In a first example scenario, the air escape may be caused by an intentional action performed by the individual 155. The intentional action may be carried out, for example, to release air from the tire 147 after overinflation of the tire 147, that is, when the tire pressure is outside of a predefined range or above a threshold.

However, in a second example scenario, the air escape may be caused by an unintentional action carried out by the individual 155 such as, for example, misaligning the connector 152 of the air hose 151 with the valve stem 138, or a faulty stem, hose, or air station.

The tire pressure monitoring system 105 distinguishes between the two scenarios by evaluating information contained in a second wireless signal received from the tire pressure sensor 137 that provides information about the air pressure inside the tire 147. Evaluating the second wireless signal can include comparing a tire pressure value provided by the tire pressure sensor 137 against a range of air pressure values or one or more threshold air pressure values. The air pressure values can encompass a first threshold air pressure value corresponding to an underinflation of the tire 147 (30 psi, for example) and a second threshold air pressure value corresponding to an overinflation of the tire 147 (50 psi, for example).

In an example implementation, the range of threshold air pressure values (30 psi to 50 psi, for example) may be preset and stored in the memory 107 of the tire pressure monitoring system 105. The preset values may be selected on the basis of various factors such as, for example, based on the type of tires provided on the vehicle 115, a range of ambient temperatures in which the vehicle 115 is operated (colder temperatures may require higher tire air pressure in comparison to hotter temperatures), and personal preferences (ride comfort of a driver or passenger, for example).

In an example implementation, the tire pressure monitoring system 105 may issue an alert when the tire pressure value provided by the tire pressure sensor 137 is outside of the range of threshold air pressure values (either below a low-end threshold air pressure value or higher than a high-end threshold air pressure value).

In another example implementation, the tire pressure monitoring system 105 may issue an alert when the tire pressure value provided by the tire pressure sensor 137 only when the tire pressure value provided by the tire pressure sensor 137 is below a low-end threshold air pressure value of the range of threshold air pressure values.

In a first case, the low-end threshold air pressure value is set to provide an indication that the tire 147 is underinflated and requires inflation. For example, the low value in this first case may be set to 25 psi when a manufacturer-recommended low end air pressure in the tire 147 is 30 psi for example. The alert in this first case is provided to the individual 155 after underinflation of the tire 147 has taken place.

In a second case, the low-end threshold air pressure value is set to provide an indication that a continuation of air escape through the valve stem 138 can lead to underinflation of the tire 147. For example, the low-end threshold air pressure value may be set to 35 psi when the manufacturer-recommended low-end value is 30 psi. The alert in this second case is provided to the individual 155 prior to underinflation of the tire 147 taking place.

The alerts may be provided by the tire pressure monitoring system 105 in any one or more of various forms such as, for example, by beeping a horn of the vehicle 115, by transmitting an audio sound or message through a speaker of the infotainment system 125, by generating haptic feedback through the vibration element 136, such as by waggling the passenger-side front wheel 135.

Haptic feedback may be provided in situations where the vehicle 115 is located in noise-free zones such as, for example, near a hospital. Information pertaining to the location of the vehicle 115 and/or the noise-free zones may be provided to the tire pressure monitoring system 105 by various sources including, for example, a navigation system (not shown) of the vehicle 115 or a server computer that is communicatively coupled to the tire pressure monitoring system 105 via a network (such as the one described above).

In an example implementation, waggling the wheel of the vehicle may be carried out by the processor by operating a steering wheel control system (not shown) of the vehicle 115. Operating the steering wheel control system to waggle the passenger-side front wheel 135 can be similar to execution of a lane-drift alert operation whereby a driver of the vehicle 115 is alerted that the vehicle 115 is inadvertently crossing a lane marking and is moving into an adjacent lane of a road. In this case, and in accordance with the disclosure, the lane-drift alert operation is executed when the vehicle 115 is parked and air is escaping out of the tire during a tire inflation operation.

Waggling of the passenger-side front wheel 135 can involve an angular back-and-forth motion of the passenger-side front wheel 135. In an example scenario, the vehicle 115 is an autonomous vehicle and waggling of the passenger-side front wheel 135 is performed automatically by the tire pressure monitoring system 105 of the autonomous vehicle. In an example embodiment, a first angle of the waggling may be relatively small such as, for example, in the form of a vibration. The vibration may be directed at providing a notification to the individual. A second larger angle of waggling may be directed, for example, at dislodging the connector 152 from the valve stem 138.

In another example embodiment, the tire pressure monitoring system 105 of the autonomous vehicle may waggle more than one wheel of the autonomous vehicle even though the connector 152 of the air hose 151 is coupled to the valve stem 138 of the passenger-side front wheel 135. For example, both the front wheels of the autonomous vehicle may be waggled.

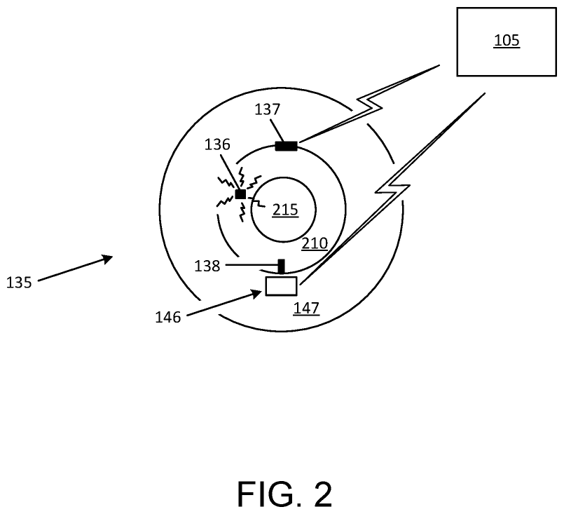

FIG. 2 shows the passenger-side front wheel 135 of the vehicle 115 and some example components that can be included in the passenger-side front wheel 135 as parts of the tire pressure monitoring system 105 in accordance with an embodiment of the disclosure. The passenger-side front wheel 135 can include the tire 147, a rim 210, and a metal hub 215. A hub cap may be placed upon the metal hub 215. The example components that can be included in the passenger-side front wheel 135 are the tire pressure sensor 137, the air flow sensor 146, and the vibration element 136.

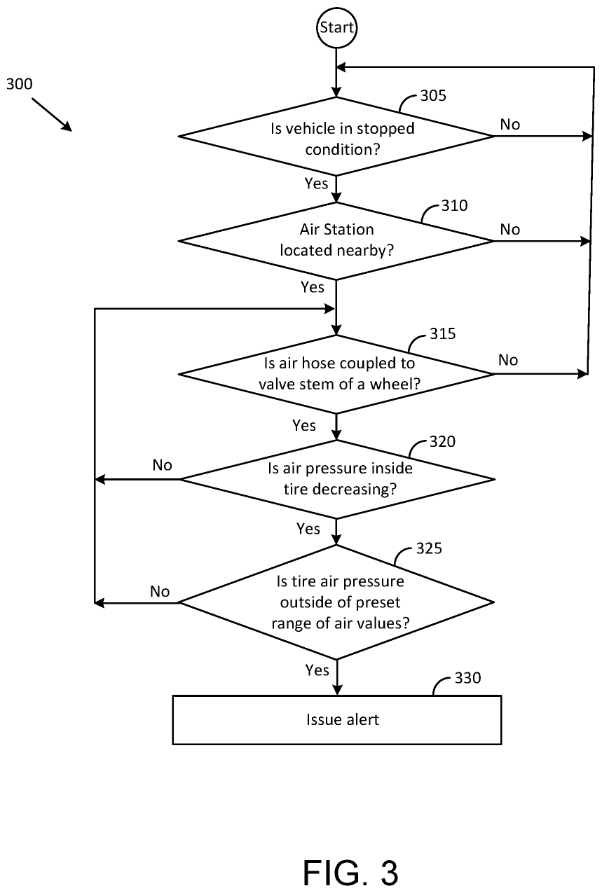

FIG. 3 shows a flowchart 300 of an example method of operation of a tire pressure monitoring system in accordance with an embodiment of the disclosure. The flowchart 300 illustrates a sequence of operations that can be implemented in hardware, software, or a combination thereof. In the context of software, the operations represent computer-executable instructions stored on one or more non-transitory computer-readable media such as the memory 107 of the tire pressure monitoring system 105, that, when executed by one or more processors such as the processor 106 of the tire pressure monitoring system 105, perform the recited operations. Generally, computer-executable instructions include routines, programs, objects, components, data structures, and the like that perform particular functions or implement particular abstract data types. The order in which the operations are described is not intended to be construed as a limitation, and any number of the described operations may be carried out in a different order, omitted, combined in any order, and/or carried out in parallel.

At block 305, a determination may be made by a tire pressure monitoring system of a vehicle whether a vehicle in which the tire pressure monitoring system is installed, is in a stopped condition. If the vehicle is not in a stopped condition, the tire pressure monitoring system continues to repeat the action indicated at block 305. If the vehicle is in a stopped condition, at block 310, the tire pressure monitoring system may make a determination whether an air station is located near the vehicle.

In an example implementation, the determination may be made by evaluating one or more images captured by a camera, and transmitted to the tire pressure monitoring system. In one example scenario, the camera is located on the vehicle. In another example scenario, the camera is located on a fixture near the vehicle, such as, for example, mounted upon a pillar on a sidewalk next to the air station. The camera that is mounted upon the pillar may be configured to wirelessly communicate with the tire pressure monitoring system, such as, for example, by using cellular, Wi-Fi, Wi-Fi direct, UWB, and/or Zigbee®.

If no air station is detected, the tire pressure monitoring system continues to repeat the actions indicated at block 305 and block 310. If an air station is detected, the tire pressure monitoring system may make a determination, at block 315, whether an air hose of the air station has been coupled to a valve stem of a wheel of the vehicle. In an example implementation, the determination may be made by evaluating one or more images captured by a camera and transmitted to the tire pressure monitoring system. Coupling the air hose to the wheel of the vehicle can include various actions such as, for example, dragging the air hose towards the wheel, coupling a connector of the air hose to a valve stem on the wheel, and depressing a lever on the air hose to initiate air flow out of the air hose.

If it is determined that an air hose of the air station has not been coupled to a valve stem of a wheel of the vehicle, then the operations indicated at block 305 and subsequent blocks are carried out.

If it is determined that an air hose of the air station has been coupled to a valve stem of a wheel of the vehicle, at block 320, in one example embodiment, a determination may be made by the tire pressure monitoring system whether air pressure inside the air is decreasing. In another example embodiment, a determination may be made by the tire pressure monitoring system whether air pressure inside the air is either decreasing or increasing.

If the air pressure inside the air is not decreasing, the actions indicated at block 315 and subsequent blocks may be carried out. Furthermore, if the air pressure inside the air is found to be increasing, the actions indicated at block 315 and subsequent blocks may be carried out. An increase in air pressure is an indication that the connector of the air hose has been correctly coupled to the valve stem of the wheel

A decrease in air pressure may be caused by an improper connection of the connector of the air hose to the valve stem of the wheel such as, for example, by pushing the connector of the air hose into the valve stem at an angle that allows air from inside the tire to escape. In some cases, a decrease may be caused by a faulty stem, hose or air station.

In an example implementation, the decrease in air pressure may be detected by evaluating a signal provided to the tire pressure monitoring system by a tire pressure sensor in the tire. Evaluating the signal may include, for example, determining a rate of decrease of air pressure inside the tire and determining whether the rate of decrease is due to air escaping out of the tire via a valve stem as a result of an improper tire inflation operation or due to a defect in the tire (a puncture, for example). Various preset rates of air escape may be used for this purpose. For example, a first rate of escape of air out of the tire via a valve stem may be higher than a second rate of escape of air out of the tire due to a puncture in the tire 147 (such as from a nail, spike, etc.).

In another example scenario, the determination may be made by the tire pressure monitoring system based on evaluating one or more signals provided to the tire pressure monitoring system by an air flow sensor in the tire. Example procedures to do so are described above.

If, at block 320, the tire pressure monitoring system makes a determination that air pressure inside the air is decreasing, at block 325, the tire pressure monitoring system makes a determination whether the air pressure in the tire is outside of a preset range of air pressure values. The preset range of air pressure values may be selected on the basis of various factors such as, for example, based on the type of tires provided on the vehicle, a range of ambient temperatures in which the vehicle is operated (colder temperatures may require higher tire air pressure in comparison to hotter temperatures), and personal preferences (ride comfort of a driver or passenger, for example).

If the air pressure in the tire is inside the preset range of air pressure values, the actions indicated at block 315 and subsequent blocks may be carried out. If the air pressure in the tire is outside the preset range of air pressure values, at block 330, the tire pressure monitoring system may issue an alert. The alert may be provided in various forms in various implementations, such as, for example, by beeping horn of the vehicle, an audio sound or message produced through a speaker of an audio system, haptic feedback through a vibration element, and/or by waggling one or more wheels of the vehicle. The tire pressure monitoring system may select a pattern of the beeping sound produced through the horn or the speaker to convey various types of alerts. For example, a slow cadence can indicate an alert that air is escaping out of the tire gradually. A fast cadence may convey a sense of urgency because the air escape out of the tire is rapid and there exists a possibility that the tire may be underinflated to an unacceptable level. The messages may vocalize such monitoring. Details pertaining to haptic feedback and waggling are described above.

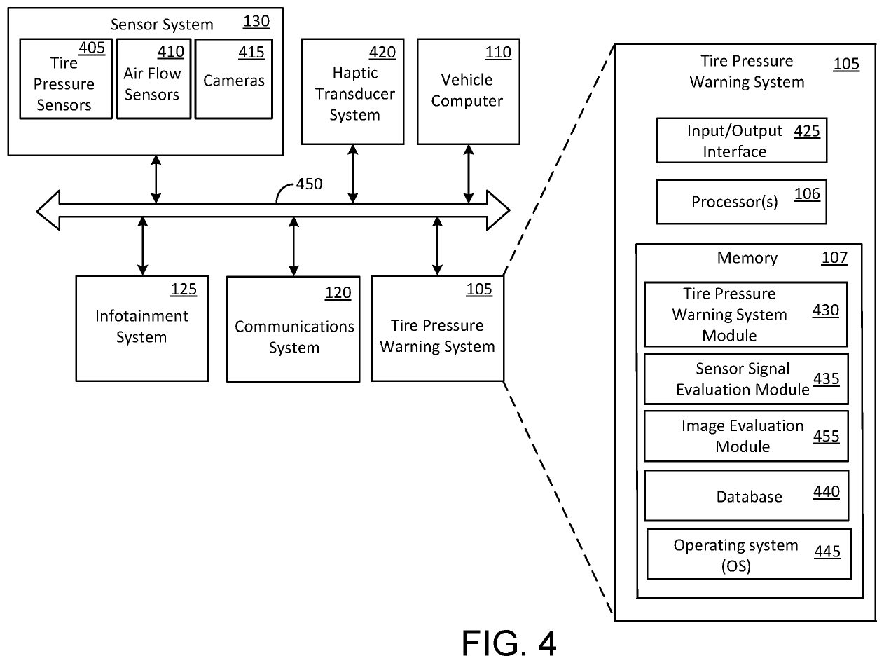

FIG. 4 shows some example components that may be included in the vehicle 115 in accordance with an example embodiment of the disclosure. The example components may include the tire pressure monitoring system 105, the vehicle computer 110, the infotainment system 125, the communications system 120, the sensor system 130, and a vibration element system 420. The sensor system 130 can include tire pressure sensors 405 (such as, for example, the tire pressure sensor 137 and the tire pressure sensor 141 described above), air flow sensors 410 (such as, for example, the air flow sensor 146 and the air flow sensor 144 described above), and cameras 415 (such as, for example, the camera 160 described above).

The vibration element system 420 can include a vibration element mounted on each wheel of the vehicle 115 (such as, for example, the vibration element 136 and the vibration element 143 described above). In an example implementation, one or more vibration elements may be mounted upon a body portion of the vehicle 115. Some example features and example operational aspects of some of the sensor components and vibration elements have been described above.

The various components are communicatively coupled to each other via one or more buses such as an example bus 450. The bus 450 may be implemented using various wired and/or wireless technologies. For example, the bus 450 can be a vehicle bus that uses a controller area network (CAN) bus protocol, a Media Oriented Systems Transport (MOST) bus protocol, and/or a CAN flexible data (CAN-FD) bus protocol. Some or all portions of the bus 450 may also be implemented using wireless technologies such as Bluetooth®, Zigbee®, or near-field-communications (NFC).

The tire pressure monitoring system 105 can include an input/output interface 425 that is configured to allow the tire pressure monitoring system 105 to receive sensor signals from the various tire pressure sensors and the various air flow sensors. In an example implementation, the sensor signals are wirelessly conveyed to the tire pressure monitoring system 105. The wireless signals may have any of various frequencies and occupy any of various frequency bandwidths such as, for example, low-frequency (LF), very-high frequency (VHF), ultra-high frequency (UHF), and cellular frequencies. In an example implementation, the sensor signals may be formatted in any of various communication formats such as, for example, Bluetooth®, cellular, NFC, Wi-Fi, Wi-Fi direct, Ultra-Wideband (UWB), and Zigbee®.

The tire pressure monitoring system 105 can further include the processor 106 and the memory 107. The memory 107, which is one example of a non-transitory computer-readable medium, may be used to store an operating system (OS) 445, a database 440, and code modules such as a tire pressure monitoring system module 430, a sensor signal evaluation module 435, and an image evaluation module 455.

The code modules are provided in the form of computer-executable instructions that can be executed by the processor 106 for performing various operations in accordance with the disclosure. In one example implementation, the tire pressure monitoring system module 430 may be executed by the processor 106 for executing various operations such as the actions described above with reference to the flowchart 300. The sensor signal evaluation module 435 may be executed by the processor 106 to evaluate sensor signals provided by the various tire pressure sensors and the air flow sensors. The image evaluation module 455 may be executed by the processor 106 to evaluate images provided by various cameras.

The database 440 may contain information such as, for example, specifications pertaining to typical tire pressure ranges, air pressure values, images, and alerts.

In the above disclosure, reference has been made to the accompanying drawings, which form a part hereof, which illustrate specific implementations in which the present disclosure may be practiced. It is understood that other implementations may be utilized, and structural changes may be made without departing from the scope of the present disclosure. References in the specification to “one embodiment,” “an embodiment,” “an example embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, one skilled in the art will recognize such feature, structure, or characteristic in connection with other embodiments whether or not explicitly described.

Implementations of the systems, apparatuses, devices, and methods disclosed herein may comprise or utilize one or more devices that include hardware, such as, for example, one or more processors and system memory, as discussed herein. An implementation of the devices, systems, and methods disclosed herein may communicate over a computer network. A “network” is defined as one or more data links that enable the transport of electronic data between computer systems and/or modules and/or other electronic devices. When information is transferred or provided over a network or another communications connection (either hardwired, wireless, or any combination of hardwired or wireless) to a computer, the computer properly views the connection as a transmission medium. Transmission media can include a network and/or data links, which can be used to carry desired program code means in the form of computer-executable instructions or data structures and which can be accessed by a general purpose or special purpose computer. Combinations of the above should also be included within the scope of non-transitory computer-readable media.

Computer-executable instructions comprise, for example, instructions and data which, when executed at a processor, cause the processor to perform a certain function or group of functions. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

A memory device such as the memory 107, can include any one memory element or a combination of volatile memory elements (e.g., random access memory (RAM, such as DRAM, SRAM, SDRAM, etc.)) and non-volatile memory elements (e.g., ROM, hard drive, tape, CDROM, etc.). Moreover, the memory device may incorporate electronic, magnetic, optical, and/or other types of storage media. In the context of this document, a “non-transitory computer-readable medium” can be, for example but not limited to, an electronic, magnetic, optical, electromagnetic, infrared, or semiconductor system, apparatus, or device. More specific examples (a non-exhaustive list) of the computer-readable medium would include the following: a portable computer diskette (magnetic), a random-access memory (RAM) (electronic), a read-only memory (ROM) (electronic), an erasable programmable read-only memory (EPROM, EEPROM, or Flash memory) (electronic), and a portable compact disc read-only memory (CD ROM) (optical). Note that the computer-readable medium could even be paper or another suitable medium upon which the program is printed, since the program can be electronically captured, for instance, via optical scanning of the paper or other medium, then compiled, interpreted or otherwise processed in a suitable manner if necessary, and then stored in a computer memory.

Those skilled in the art will appreciate that the present disclosure may be practiced in network computing environments with many types of computer system configurations, including in-dash vehicle computers, personal computers, desktop computers, laptop computers, message processors, handheld devices, multi-processor systems, microprocessor-based or programmable consumer electronics, network PCs, minicomputers, mainframe computers, mobile telephones, PDAs, tablets, pagers, routers, switches, various storage devices, and the like. The disclosure may also be practiced in distributed system environments where local and remote computer systems, which are linked (either by hardwired data links, wireless data links, or by any combination of hardwired and wireless data links) through a network, both perform tasks. In a distributed system environment, program modules may be located in both the local and remote memory storage devices.

Further, where appropriate, the functions described herein can be performed in one or more of hardware, software, firmware, digital components, or analog components. For example, one or more application specific integrated circuits (ASICs) can be programmed to carry out one or more of the systems and procedures described herein. Certain terms are used throughout the description, and claims refer to particular system components. As one skilled in the art will appreciate, components may be referred to by different names. This document does not intend to distinguish between components that differ in name, but not function.

It should be noted that the sensor embodiments discussed above may comprise computer hardware, software, firmware, or any combination thereof to perform at least a portion of their functions. For example, a sensor may include computer code configured to be executed in one or more processors and may include hardware logic/electrical circuitry controlled by the computer code. These example devices are provided herein for purposes of illustration and are not intended to be limiting. Embodiments of the present disclosure may be implemented in further types of devices, as would be known to persons skilled in the relevant art(s).

At least some embodiments of the present disclosure have been directed to computer program products comprising such logic (e.g., in the form of software) stored on any computer-usable medium. Such software, when executed in one or more data processing devices, causes a device to operate as described herein.

While various embodiments of the present disclosure have been described above, it should be understood that they have been presented by way of example only, and not limitation. It will be apparent to persons skilled in the relevant art that various changes in form and detail can be made therein without departing from the spirit and scope of the present disclosure. Thus, the breadth and scope of the present disclosure should not be limited by any of the above-described example embodiments but should be defined only in accordance with the following claims and their equivalents. The foregoing description has been presented for the purposes of illustration and description. It is not intended to be exhaustive or to limit the present disclosure to the precise form disclosed. Many modifications and variations are possible in light of the above teaching. Further, it should be noted that any or all of the aforementioned alternate implementations may be used in any combination desired to form additional hybrid implementations of the present disclosure. For example, any of the functionality described with respect to a particular device or component may be performed by another device or component. Further, while specific device characteristics have been described, embodiments of the disclosure may relate to numerous other device characteristics. Further, although embodiments have been described in language specific to structural features and/or methodological acts, it is to be understood that the disclosure is not necessarily limited to the specific features or acts described. Rather, the specific features and acts are disclosed as illustrative forms of implementing the embodiments. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

That which is claimed is:

1. A method comprising:
detecting, by a processor in a vehicle, a tire inflation operation performed upon a wheel of the vehicle;
determining, by the processor, during the tire inflation operation, that air is escaping out of a tire of the wheel of the vehicle; and
issuing, by the processor, an alert based on determining that air is escaping out of the tire.

2. The method of claim 1, wherein determining that air is escaping out of the tire comprises:
receiving, by the processor, from a tire pressure sensor located in the tire, a wireless sensor signal containing information about an air pressure inside the tire; and
evaluating the information to determine whether the air pressure inside the tire is dropping during the tire inflation operation.

3. The method of claim 2, wherein issuing the alert upon detecting that the air pressure inside the tire is below a preset air pressure value.

4. The method of claim 1, wherein issuing the alert comprises:
outputting a haptic feedback signal through a vibration element located in at least one of the wheel of the vehicle or on a body portion of the vehicle.

5. The method of claim 1, wherein issuing the alert comprises:
waggling the wheel of the vehicle.

6. The method of claim 1, wherein determining that air is escaping out of the tire comprises:
receiving, by the processor, from an air flow sensor, a wireless sensor signal, and
determining, by the processor, based on evaluating the wireless sensor signal that air is escaping out of the tire through a valve stem.

7. The method of claim 6, wherein issuing the alert comprises:
emitting an audio signal through at least one of a horn of the vehicle or a speaker of an audio system the vehicle based on determining that air is escaping out of the tire through the valve stem.

8. The method of claim 1, wherein detecting the tire inflation operation comprises:
receiving, by the processor, from a camera, an image that includes an air hose; and
detecting, by the processor based on evaluating the image, coupling of the air hose to a valve stem of the wheel.

9. A method comprising:
detecting, by a processor in a vehicle, a tire inflation operation performed upon a tire of a wheel of the vehicle;
receiving, by the processor, from a tire pressure sensor located in the tire, a wireless sensor signal containing information about an air pressure inside the tire;
evaluating, by the processor, the information to determine whether an air pressure inside the tire of the wheel is dropping during the tire inflation operation; and
issuing, by the processor, an alert based on determining that the air pressure inside the tire is dropping during the tire inflation operation.

10. The method of claim 9, wherein issuing the alert comprises:
outputting a haptic feedback signal through a vibration element located in the wheel of the vehicle.

11. The method of claim 10, wherein the vibration element is a motor.

12. The method of claim 9, wherein issuing the alert comprises:
waggling the wheel of the vehicle.

13. The method of claim 12, wherein waggling the wheel of the vehicle comprises:
operating, by the processor, a steering wheel control system of the vehicle to waggle the wheel.

14. The method of claim 1, wherein determining that air is escaping out of the tire comprises:
receiving, by the processor, from an air flow sensor, a wireless sensor signal, and
determining, by the processor, based on evaluating the wireless sensor signal that air is escaping out of the tire through a valve stem of the wheel.

15. A vehicle comprising:
a tire pressure sensor mounted in a wheel of the vehicle; and
a tire pressure monitoring system comprising:
a memory that stores computer-executable instructions; and
a processor configured to access the memory and execute the computer-executable instructions to perform operations comprising:
detecting a tire inflation operation performed upon the wheel of the vehicle;
determining that air is escaping out of a tire of the wheel of the vehicle during the tire inflation operation; and
issuing, an alert based on determining that air is escaping out of the tire.

16. The vehicle of claim 15, wherein determining that air is escaping out of the tire during the tire inflation operation, comprises:
evaluating a wireless sensor signal received from the tire pressure sensor during the tire inflation operation; and
detecting that an air pressure inside the tire has fallen below a preset air pressure value.

17. The vehicle of claim 15, further comprising an air flow sensor, and wherein the processor is further configured to access the memory and execute the computer-executable instructions to perform operations comprising:
receiving from the air flow sensor, information about a passage of air through a valve stem and out of the tire; and
determining that an air pressure inside the tire has fallen below a preset air pressure value due to the passage of air through the valve stem and out of the tire.

18. The vehicle of claim 15, further comprising a vibration element located in the wheel of the vehicle and wherein the processor is further configured to access the memory and execute the computer-executable instructions to perform operations comprising:
outputting a haptic feedback signal through the vibration element based on determining that air is escaping out of the tire during the tire inflation operation.

19. The vehicle of claim 15, wherein the processor is further configured to access the memory and execute the computer-executable instructions to perform operations comprising:
waggling the wheel of the vehicle based on determining that air is escaping out of the tire during the tire inflation operation.

20. The vehicle of claim 15, further comprising a camera and wherein the processor is further configured to access the memory and execute the computer-executable instructions to perform operations comprising:
receiving from the camera an image that includes an air hose; and
detecting the tire inflation operation based on evaluating the image and detecting coupling of the air hose to a valve stem of the wheel.
